(19) United States
(12) Patent Application Publication
(10) Pub. No.: US 2014/0151479 A1
(43) Pub. Date: Jun. 5, 2014

(54) Food Heating Device

(71) Applicant: Te-Sheng Wu, Taoyuan County (TW)

(72) Inventor: Te-Sheng Wu, Taoyuan County (TW)

(21) Appl. No.: 13/691,086

(22) Filed: Nov. 30, 2012

(51) Int. Cl. A47J 43/08

(52) U.S. Cl. CPC A47J 43/085
USPC 241/66

(57) ABSTRACT

A food heating device contain: a cup and a base used to hold the cup and including a transmission mechanism. The cup includes plural ribs mounted around an inner wall thereof, and each rib extends downwardly along the inner wall of the cup. The cup also includes plural protrusions fixed on a bottom end thereof and a shaft secured at a central position of the bottom end thereof. The shaft has a blade disposed on a top end thereof, such that the shaft is inserted through the bottom end of the cup and is connected with a transmission mechanism via a bearing. Thereby, ingredients are crushed into juices after the transmission mechanism drives the blade, and during a crushing process, the shaft nibs with the bearing to produce a high temperature, and the ingredients are crashed in the cup by the plural ribs and the protrusions to be heated quickly.

### FIELD OF THE INVENTION

The present invention relates to a heating device, and more particularly to a food heating device which allows crushing ingredients into juices and producing a high temperature resulting from a rub of a bearing, and the ingredients are crashed in a cup to be heated quickly.

### BACKGROUND OF THE INVENTION

A conventional food processor, such as a soybean milk machine, is used to crush ingredients into juices and to heat crushed ingredients in a cup by means of a heating element. However, such a conventional food processor heats the ingredients after crushing the ingredients into juices, so it cannot crush and heat the ingredients simultaneously, such that the flavor of ingredients cannot be maintained.

The present invention has arisen to mitigate and/or obviate the afore-described disadvantages.

### SUMMARY OF THE INVENTION

The primary object of the present invention is to provide a food heating device which allows crushing ingredients into juices and producing a high temperature resulting from a nib of a bearing during a crushing process, and the ingredients are crashed in a cup to be heated quickly.

To obtain the above objective, a food heating device provided by the present invention contains:

a cup;

a base used to hold the cup and including a transmission mechanism;

wherein the cup includes a plurality of ribs mounted around an inner wall thereof, and each rib extends downwardly along the inner wall of the cup;

wherein the cup also includes a plurality of protrusions fixed on a bottom end thereof and a shaft secured at a central position of the bottom end thereof, and the shaft has a blade disposed on a top end thereof, such that the shaft is inserted through the bottom end of the cup and is connected with a transmission mechanism via a bearing.

Thereby, ingredients are crushed into juices after the transmission mechanism drives the blade, and during a crushing process, the shaft nibs with the bearing to produce a high temperature, and the ingredients are crashed in the cup by the plurality of ribs and the protrusions to be heated quickly.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view showing the assembly of a cup and a base of a food heating device according to a preferred embodiment of the present invention.

FIG. 2 is a cross sectional view showing the assembly of the food heating device according to the preferred embodiment of the present invention.

FIG. 3 is a cross sectional view showing the operation of the food heating device according to the preferred embodiment of the present invention.

FIG. 4 is a top plan view showing the operation of the food heating device according to the preferred embodiment of the present invention.

### DETAILED DESCRIPTION OF THE PREFERRED EMBODIMENTS

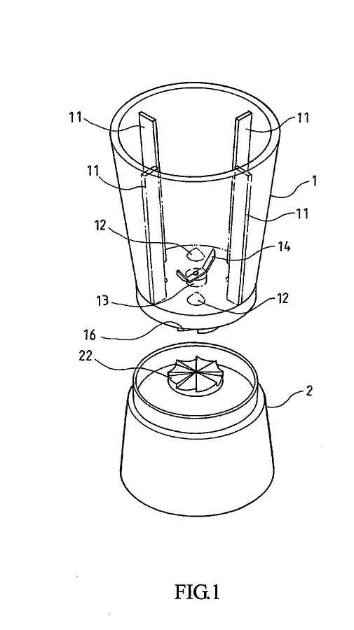

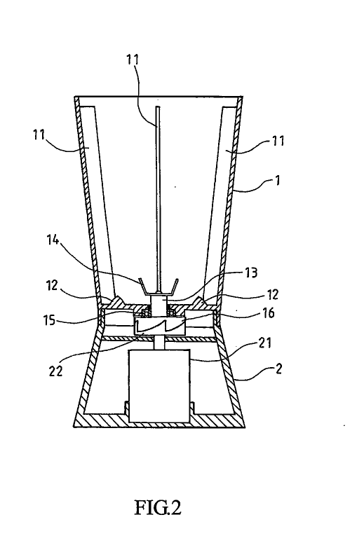

FIG. 1 is a perspective view showing the assembly of a cup and a base of a food heating device according to a preferred embodiment of the present invention. FIG. 2 is a cross sectional view showing the assembly of the food heating device according to the preferred embodiment of the present invention. Referring to FIGS. 1 and 2, a food heating device of the present invention comprises: a cup 1 and a base 2 for holding the cup 1, wherein the cup 1 includes a plurality of ribs 11 mounted around an inner wall thereof, and each rib 11 has a top rim adjacent to a mouth of the cup 1 and extends downwardly along the inner wall of the cup 1. In this embodiment, four ribs 11 are equidistantly mounted around the inner wall of the cup 1 and are spaced apart from each other. The cup 1 also includes a plurality of protrusions 12 fixed on a bottom end thereof. In this embodiment, four protrusions 12 are fixed on the bottom end of the cup 1, and each protrusion 12 is formed in a sharp cone shape and is defined between two ribs 11. Furthermore, the cup 1 includes a shaft 13 secured at a central position of the bottom end thereof, and the shaft 13 has a blade 14 disposed on a top end thereof, such that the shaft 13 is inserted through the bottom end of the cup 1 and a bearing 15 and is connected with a first toothed member 16 under the bearing 15. The base 2 includes a transmission mechanism 21 (such as a motor), and the transmission mechanism 21 has a second toothed member 22 mounted thereon for meshing with the first toothed member 16.

In operation, the cup 1 is placed on the base 1, and the first toothed member 16 meshes with the second toothed member 22, then ingredients are putted into the cup 1. When the food heating device operates, the transmission mechanism 21 drives the blade 14 to rotate rapidly through the shaft 13 so that the ingredients are crushed into juices during which the shaft 13 rubs with the bearing 15, so a high temperature produces. And then, the ingredients are mixed together and crashed one another by ways of the plurality of ribs 11 and protrusions 12 so as to be heated quickly.

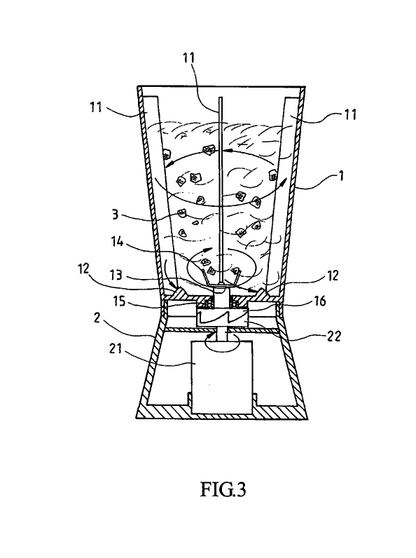

FIG. 3 is a cross sectional view showing the operation of the food heating device according to the preferred embodiment of the present invention. In operation, the cup 1 is placed on the base 2 so that the first toothed member 16 meshes with the second toothed member 22, and then the ingredients 3 are putted into the cup 1. After the food heating device is powered on, the transmission mechanism 21 drives the blade 14 to rotate rapidly through the shaft 13 so that the ingredients 3 are crushed into juices, thereby facilitating following heating process.

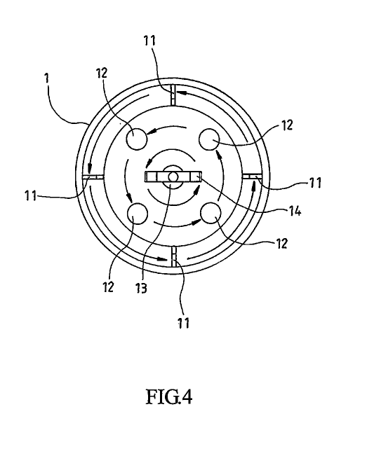

FIG. 4 is a top plan view showing the operation of the food heating device according to the preferred embodiment of the present invention. Referring further to FIGS. 3 and 4, during the shaft 13 rotates, it nibs with the bearing 15 to produce the high temperature which is transmitted toward the cup 1 via the shaft 13 so as to heat the ingredients 3. Also, during the ingredients 3 are crushed and mixed together in the cup 1, they are crashed by the plurality of ribs 11 and the protrusions 12 so as to be heated rapidly.

Thereby, the base of the food heating device includes the transmission mechanism, and the cup of the food heating device includes the plurality of ribs and protrusions, such that the ingredients are crushed into the juices, and during a crushing process, the shaft nibs with the bearing to produce the high temperature. In addition, the ingredients are crashed in the cup to be heated quickly and easily.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A food heating device comprising:
a cup;
a base used to hold the cup and including a transmission mechanism;
wherein the cup includes a plurality of ribs mounted around an inner wall thereof, and each rib extends downwardly along the inner wall of the cup;
wherein the cup also includes a plurality of protrusions fixed on a bottom end thereof and a shaft secured at a central position of the bottom end thereof, and the shaft has a blade disposed on a top end thereof, such that the shaft is inserted through the bottom end of the cup and is connected with a transmission mechanism via a bearing;
thereby, ingredients are crushed into juices after the transmission mechanism drives the blade, and during a crushing process, the shaft nibs with the bearing to produce a high temperature, and the ingredients are crashed in the cup by the plurality of ribs and the protrusions to be heated quickly.

2. The food heating device as claimed in claim 1, wherein the shaft is inserted through the bottom end of the cup and a bearing and is connected with a first toothed member under the bearing, and the transmission mechanism of the base has a second toothed member mounted thereon for meshing with the first toothed member, such that the transmission mechanism drives the shaft to rotate and then drives the blade to rotate rapidly.

3. The food heating device as claimed in claim 1, wherein each protrusion is formed in a sharp cone shape.

4. The food heating device as claimed in claim 1, wherein the transmission device of the base is a motor.

5. The food heating device as claimed in claim 1, wherein the plurality of ribs are equidistantly mounted around the inner wall of the cup and are spaced apart from each other.

6. The food heating device as claimed in claim 1, wherein each protrusion is defined between two ribs.
